(19) United States
(12) Patent Application Publication
(10) Pub. No.: US 2026/0086738 A1
(43) Pub. Date: Mar. 26, 2026

(54) APPARATUS AND METHOD FOR SCHEDULING I/O REQUESTS INPUT ALONG WITH OVERLAPPED ADDRESS FOR PARALLEL PROCESSING IN MEMORY SYSTEM

(71) Applicant: SK hynix Inc., Gyeonggi-do (KR)

(72) Inventor: Ki Tae KIM, Gyeonggi-do (KR)

(21) Appl. No.: 19/062,016

(22) Filed: Feb. 25, 2025

(30) Foreign Application Priority Data
Sep. 23, 2024 (KR) 10-2024-0128053

(51) Int. Cl. G06F 3/06

(52) U.S. Cl. CPC G06F 3/0659; G06F 3/061; G06F 3/0679

(57) ABSTRACT

A memory system includes a memory device and a controller. The memory device includes at least one storage region. The controller is coupled to the memory device. The controller is configured to transmit to the memory device a command used for storing data in the at least one storage region or reading stored data from the at least one storage region. The controller is configured to differently perform scheduling, based on whether addresses, input along with at least two commands belonging to a preset range of commands to be transmitted to the memory device, are overlapped, so that a first order in which the commands are input from an external device is equal to a second order in which the commands are transmitted to the memory device.

### CROSS-REFERENCE TO RELATED APPLICATIONS

This patent application claims the benefit of priority under 35 U.S.C. § 119(a) to Korean Patent Application No. 10-2024-0128053, filed on Sep. 23, 2024, the entire disclosure of which is incorporated herein by reference.

### TECHNICAL FIELD

One or more embodiments of the present disclosure described herein relate to a memory system, and more particularly, to an apparatus and a method for scheduling input/output requests input along with at least one overlapping address for parallel processing within a memory system.

### BACKGROUND

A memory system may include a volatile memory or a non-volatile memory. The memory system may include various components for efficiently operating the volatile memory or the non-volatile memory. The memory system may perform parallel processing for plural requests, input from an external device, to improve data input/output speed and performance.

### BRIEF DESCRIPTION OF THE DRAWINGS

The description herein makes reference to the accompanying drawings wherein like reference numerals refer to like parts throughout the figures.

FIG. 1 illustrates a memory system according to an embodiment of the present disclosure.

FIG. 2 illustrates a controller according to an embodiment of the present disclosure.

FIG. 3 illustrates a first case for checking whether an address is overlapped.

FIG. 4 illustrates a second case for checking whether the address is overlapped.

FIG. 5 illustrates an operation of the controller when the address is overlapped according to an embodiment of the present disclosure.

FIG. 6 illustrates a case where consistency is maintained in the memory system.

FIG. 7 illustrates a case where the consistency is broken in the memory system.

FIG. 8 illustrates another controller according to an embodiment of the present disclosure.

FIG. 9 illustrates yet another controller according to an embodiment of the present disclosure.

FIG. 10 illustrates a memory system according to an embodiment of the present disclosure.

FIG. 11 illustrates a data processing apparatus according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine’, ‘circuitry’ or ‘logic’ also covers an implementation of merely a processor or multiple processors or a portion of a processor and its (or their) accompanying software and/or firmware. The term ‘machine’, ‘circuitry’ or ‘logic’ also covers, for example, and if applicable to a particular claim element, an integrated circuit for a storage device.

As used herein, the terms ‘first’, ‘second’, ‘third’, and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect determination. The determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the present disclosure can provide an apparatus and a method which are capable of improving performance of a memory device or a memory system including the memory device.

In addition, an embodiment of the present disclosure can provide an apparatus and an operation method for maintaining data consistency in a parallel processing scheme for a plurality of data input/output (I/O) commands or requests. The apparatus can have a structure capable of parallel processing in order to enhance or improve data input/output (I/O) performance of a memory system.

Further, an embodiment of the present disclosure can provide a scheduling apparatus and an operation method capable of controlling or adjusting a transmission or processing order of data I/O commands or requests based on whether addresses individually input along with different commands or requests are overlapped during a procedure of processing a plurality of data I/O commands or requests in a memory system, thereby keeping or maintaining data consistency to improve the data I/O performance.

In addition, an embodiment of the present disclosure can provide a scheduling apparatus and an operation method capable of controlling the transmission or processing order of data I/O commands through selective processing regarding a write command or a read command based on whether addresses individually input along with different commands or requests are overlapped, thereby maintaining the data consistency and improving the data I/O performance.

An embodiment of the present disclosure provides a memory system including a memory device comprising at least one storage region; and a controller coupled to the memory device and configured to transmit to the memory device a command used for storing data in the at least one storage region or reading stored data from the at least one storage region. The controller can be configured to differently perform scheduling, based on whether addresses, input along with at least two commands belonging to a preset range of commands to be transmitted to the memory device, are overlapped, so that a first order in which the commands are input from an external device is equal to a second order in which the commands are transmitted to the memory device.

The controller can be configured to compare addresses corresponding to a specific command with addresses corresponding to at least one of a first command and a second command to determine whether the addresses are overlapped, the first command input immediately before the specific command, the second command input immediately after the specific command.

The controller can be configured to transmit to the memory device the specific command after transmitting the first command when at least one of the addresses corresponding to the specific command is equal to at least one of the addresses corresponding to the first command.

The controller can be configured to transmit to the memory device the specific command before transmitting the second command when at least one of the addresses corresponding to the specific command is equal to at least one of the addresses corresponding to the second command.

The controller can be configured to change a transmitting order of the specific command, the first command, and the second command, based on a type of the specific command, the first command, and the second command, when none of the addresses corresponding to the specific command is equal to the addresses corresponding to the first command or the addresses corresponding to the second command.

The controller can be configured to determine whether to perform the scheduling regardless of types of the commands.

The controller can include a command range blocker configured to determine whether to process or handle the commands; a command fetcher configured to determine whether the addresses are overlapped, after receiving the commands transmitted from the command range blocker, and transmit the commands to different paths based on types of the commands; a write processing unit configured to receive a write command from the command fetcher and process or handle the write command; a read processing unit configured to receive a read command from the command fetcher and process or handle the read command; and a buffer configured to store the write or read command transmitted from the write processing unit or the read processing unit, sequentially transmit the stored write or read command to the memory device, and link a response transmitted from the memory device with the transmitted write or read command.

The command fetcher can be further configured to assign a number to a command transmitted from the command range blocker according to a transmitting order based on whether the addresses are overlapped. The controller can further include a command counter configured to: check the number assigned to the command which is to be processed by the write processing unit or the read processing unit; and adjust or change an order of processing the command in the write processing unit or the read processing unit based on the first order.

The command fetcher can be configured to request the command range blocker to block transmission of one of the read command or the write command based on whether the addresses are overlapped. The command range blocker can be configured to block the transmission of one of the read command or the write command based on a request of the command fetcher.

The addresses can include logical addresses used by the external device. Each of the write processing unit and the read processing unit can include a Flash Translation Layer (FTL).

In another embodiment, a method for operating a memory system can include determining whether addresses, input along with at least two commands belonging to a preset range of commands to be transmitted to the memory device, are overlapped; performing scheduling, so that a first order in which the commands are input from an external device is equal to a second order in which the commands are transmitted to the memory device, when the addresses are overlapped; processing the commands without the scheduling when the addresses are not overlapped; and sequentially transmitting processed or scheduled commands to a memory device.

The determining whether the addresses are overlapped can include comparing addresses corresponding to a specific command with addresses corresponding to at least one of a first command and a second command, the first command input immediately before the specific command, the second command input immediately after the specific command; and determining whether the addresses are overlapped based on a comparison result.

The performing scheduling can include transmitting the specific command to the memory device after transmitting the first command based on the comparison result; and transmitting the specific command to the memory device before transmitting the second command based on the comparison result.

The processing the commands can include processing the specific command, the first command, and the second command based on types of the specific command, the first command, and the second command regardless of an input order of the specific command, the first command, and the second command.

The performing the scheduling can include assigning a number according to an input order to each of the commands based on whether the addresses are overlapped; and sequentially processing each of the commands based on an assigned number.

The performing the scheduling can include suspending transmission of one of a read command and a write command based on whether the addresses are overlapped.

In another embodiment, a memory system can include a memory device storing data; and a controller configured to make a first order in which read commands and write commands are input from an external device and a second order in which the read commands and the write commands are transmitted to the memory device to be identical when at least one of addresses input along with the read commands and the write commands is overlapped, while processing the read commands and the write commands to be transmitted to the memory device through separate paths in the controller.

The controller can be configured to transmit the read commands and the write commands to the memory device through the separate paths regardless of the first order in which the read commands and the write commands are input from the external device when at least one of addresses input along with the read commands and the write commands is not overlapped.

The controller can be configured to: assign numbers to the read commands and the write commands based on the first order in which the read commands and the write commands are input from the external device; and transmit the read commands and the write commands to the memory device based on an order of the assigned numbers.

The controller can be configured to suspend transmission of either the read commands or the write commands when the at least one of the addresses is overlapped.

These and other features and advantages of the invention will become apparent from the detailed description and the accompanying drawings of embodiments of the present disclosure. Embodiments will now be described with reference to the accompanying drawings, wherein like numbers reference like elements.

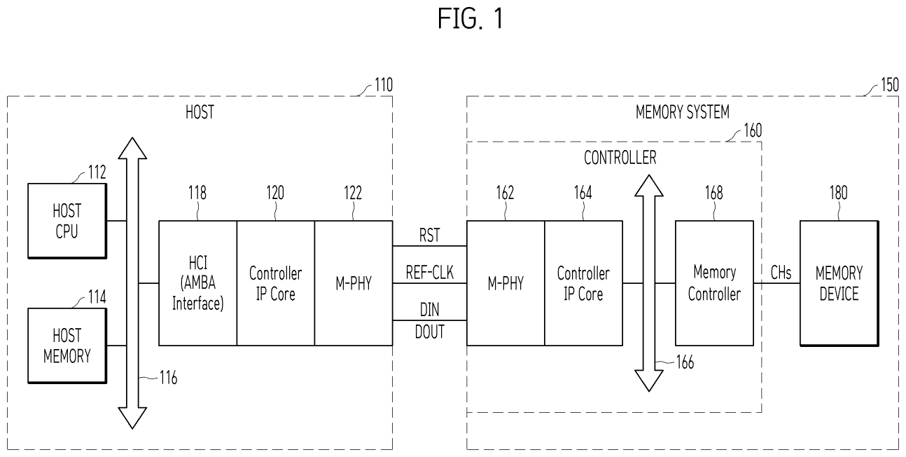

FIG. 1 illustrates a memory system according to an embodiment of the present disclosure.

Referring to FIG. 1, a first data processing apparatus can include a host 110 and a memory system 150. The host 110 and the memory system 150 can include a Universal Flash Storage (UFS) electrical interface. The memory system 150 can have characteristics of UFS memory device. The characteristics can include low power consumption, high data throughput, low electromagnetic interference, and large memory subsystem efficiency optimization. The UFS electrical interface may be based on a differential interface suggested by a Mobile Industry Processor Interface (MIPI) M-PHY specification, which establishes and supports interconnection of the UFS interface with a MIPI Unified Protocol (UniPro) specification.

According to an embodiment, the host 110 can be an entity or a device that has the characteristics of a computing device that includes one or more Small Computer System Interface (SCSI) initiator devices. The host 110 and the memory system 150 may use a predetermined set of rules or procedures for data communication or a preset interface to transmit and receive data therebetween. Examples of sets of rules or procedures for data communication standards or interfaces supported by the host 110 and the memory system 150 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), United Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host 110 and the memory system 150 may be coupled to each other through a Universal Serial Bus (USB). The Universal Serial Bus (USB) is a highly scalable, hot-pluggable, plug-and-play serial interface that ensures cost-effective, standard connectivity to peripheral devices such as keyboards, mice, joysticks, printers, scanners, storage devices, modems, video conferencing cameras, and the like.

According to embodiments, the memory system 150 can be implemented as any of various types of storage devices such as a solid state drive (SSD), a multi-media card (MMC), an embedded MMC (eMMC), a reduced size MMC (RS-MMC), or a micro-MMC, a Secure Digital (SD) card in a form of the micro-SD, a Universal Storage Bus (USB) storage device, a Universal Flash Storage (UFS) device, a compact flash (CF) card, a Smart Media card, a Memory Stick, and etc.

The host 110 can include a host central processing unit (CPU) 112, a host memory 114, a bus interface 116, a host controller interface (HCI) 118, at least one controller IP core 120, and a physical layer (M-PHY) 122. Herein, a controller IP core can include intellectual property blocks or pre-designed and pre-verified components used or embedded in semiconductor chips or integrated circuits (ICs). The host central processing unit 112 may be capable of executing at least one application. The host memory 114 may store data to be transmitted to the host central processing unit 112 or data generated by the host central processing unit 112. The bus interface 116 may be an interface for communication between components included in the host 110. The host controller interface 118 may output or receive data to or from an external device (e.g., memory system 150) coupled to the host 110. The at least one controller IP core 120 may perform various functions such as data, command or control signal transmission, error handling, power management, and the like. The physical layer 122 may perform communication based on the MIPI M-PHY specification.

The at least one controller IP core 120 can manage and control communication between the host 110 and the memory system 150. For example, the controller IP core 120 can be used to transmit data from the host 110 to the memory system 150, and to perform operations for detecting and recovering an error occurring in data that is transmitted from the memory system 150 to the host 110.

The physical layer 122 can perform communication according to a serial communication protocol developed by the Mobile Industry Processor Interface (MIPI) organization. The physical layer 122 can be designed for high-speed data transmission used in mobile devices and other low-power devices. The physical layer 122 can be used for communication between various devices such as mobile displays, cameras, sensors, memory, etc., depending on the embodiment. In particular, the physical layer 122 can support low-power operation so that the physical layer 122 can minimize power consumption to extend a life of a battery embedded in mobile devices. In addition, the physical layer 122 can provide a high bandwidth and a fast data transmission speed via a parallel processing scheme using a multi-lane architecture, meeting the needs of high-definition video and large file transmission.

The host controller interface 118 can provide communication with the at least one controller IP core 120 and other components coupled via the bus interface 116. For example, an AMBA (Advanced Microcontroller Bus Architecture) is a bus-based communication protocol and interface developed by ARM Ltd . . . An AMBA interface, which includes AXI (Advanced eXtensible Interface), AHB (Advanced High-performance Bus), or APB (Advanced Peripheral Bus), can be used for communication between intellectual property (IP) cores in System-on-Chip (SoC) designs. Further, the bus interface 116 can also support exchange of data or control signals between various components and the at least one controller IP core 120, which are included in the host 110.

Referring to FIG. 1, the physical layer 122 in the host 110 can transmit or receive, to or from the memory system 150, a reset signal (RST), a reference clock (REF-CLK), input data or write data (DIN), and output data or read data (DOUT).

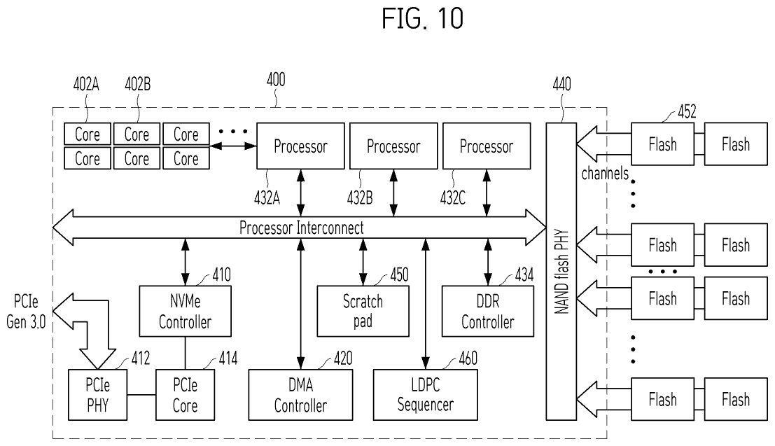

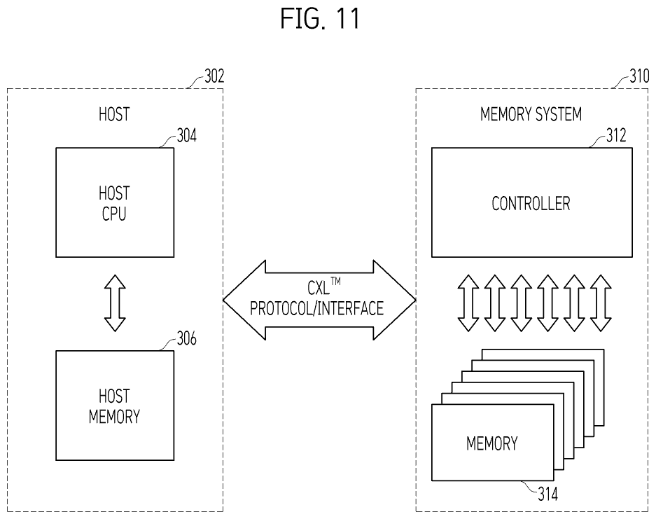

The memory system 150 can include a controller 160 and a memory device 180. Herein, the memory device 180 may include at least one data storage space including volatile memory cells or non-volatile memory cells. A description of the memory device 180 will be described later with reference to FIGS. 10 and 11.

The controller 160, which is coupled to the memory device 180 through at least one channel (CHs), can receive signals, commands, or data input from the host 110 and perform operations responsive to the signals, the commands, the data. For example, the controller 160 can store data in the memory device 180 when the data is input from the host 110. The controller 160 can transmit, to the host 110, data, which is requested by the host 110 and received from the memory device 150. The controller 160 may include a physical layer (M-PHY) 162, at least one controller IP core 164, a bus interface 166, and a memory controller 168.

The controller 160 included in the memory system 150 can include the physical layer 162 that is substantially similar to the physical layer 122 included in the host 110. The physical layer 162 may receive or transmit signals or data transmitted from or to the host 110. For example, the physical layer 162 and the physical layer 122 can operate as counter parts to each other.

According to an embodiment, the at least one controller IP core 164 in the memory system 150 can be substantially the same as the at least one controller IP core 120 in the host 110. In another embodiment, the at least one controller IP core 164 can be different from the at least one controller IP core 120. The configuration of the at least one controller IP core 164 can be determined or established in response to the bus interface 166 that supports communication between various components included in the memory system 150.

The memory controller 168 may be designed or configured based on the configuration of the memory device 180. For example, when the memory device 180 is a flash memory, the memory controller 168 may support communication with a flash memory such as a NAND or NOR device. For example, the memory controller 168 can support communication schemes and protocols set in the ONFI (Open NAND Flash Interface). The ONFI can use a data path (e.g., a channel, a way, etc.) that includes signal lines that are capable of supporting bidirectional transmission and reception of 8-bit or 16-bit data units between different components. Data communication between the controller 160 and the memory device 180 can be performed through a device that supports an interface designed for at least one scheme among asynchronous SDR (Asynchronous Single Data Rate), synchronous DDR (Synchronous Double Data Rate), and Toggle DDR (Toggle Double Data Rate).

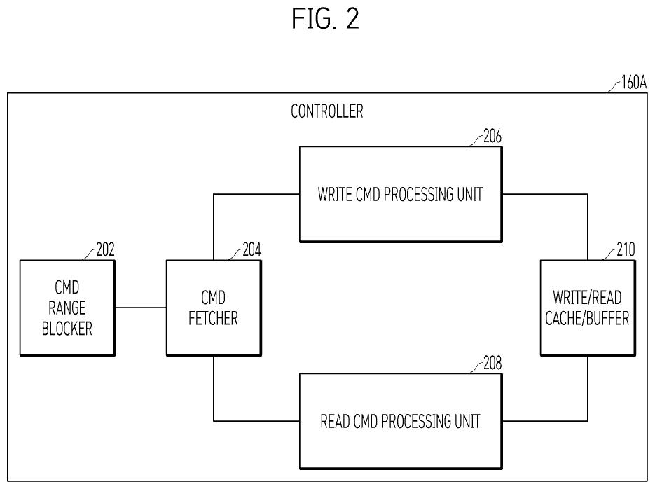

FIG. 2 illustrates a controller according to an embodiment of the present disclosure.

Referring to FIG. 2, the controller 160A can include a parallel processing structure or a pipelining structure that can process or handle read commands and write commands through different plural paths.

The controller 160A can include a command range blocker 202 that determines whether to process or handle data input/output (I/O) commands. The command range blocker 202 can determine whether an externally input data I/O command such as a read or write command or a read or write request will be processed by the controller 160A. If there is a concern that an error or hazard may occur in a procedure in which the controller 160A processes or handles the plural data I/O commands, the command range blocker 202 can block or obstruct the externally input data input/output command from being processed by an internal component. For example, the command range blocker 202 can limit or restrict an accessed range within the memory device 180 or block or allow access to a specific storage region for preventing or avoiding damage to important or critical data, to improve data safety, data security, or data reliability.

Here, processing or handling regarding a command or a request can include at least one internal operation or task which the controller 160A can perform in response to the command or the request. As an example of the internal operation, the controller 160A can perform an operation of translating a logical address, input along with a data I/O command input from an external device such as the host 110, into a physical address because the memory system 150 described in FIG. 1 uses the physical address unlike the logical address used by the host 110. According to an embodiment, the controller 160A could check whether a data I/O command input from the host 110 is valid, and check whether there is an error in write data input along with a write command among the data I/O commands. In addition, when the host 110 and the memory system 150 can perform data communication through a protocol associated with security, the controller 160A can check or handle a security-related issue.

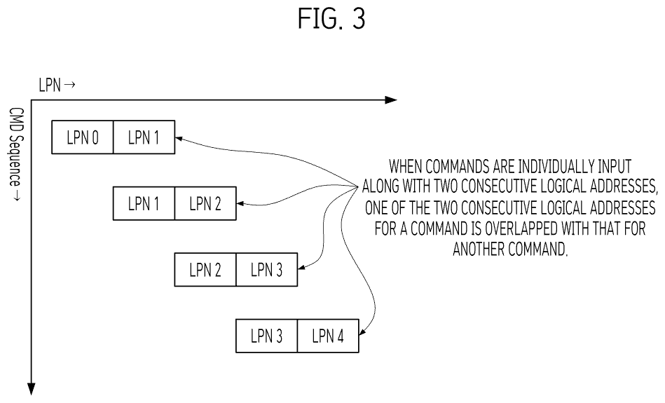

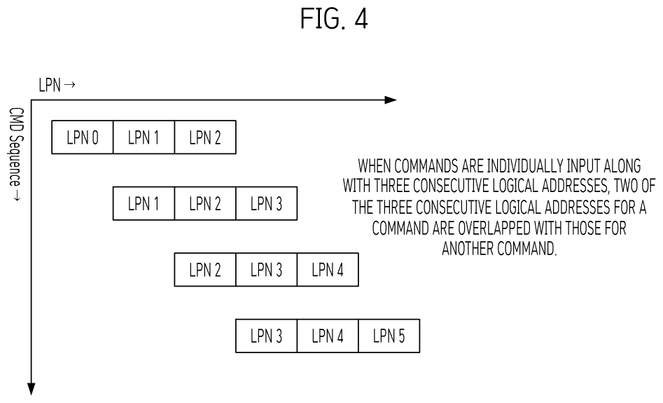

The command range blocker 202 can transmit the data I/O command to the command fetcher 204 without blocking or suspending the data I/O command. The command fetcher 204 can determine whether at least one address is overlapped after receiving the data I/O command transmitted from the command range blocker 202 and transmit the received data I/O command through different paths based on a type of the data I/O command. Herein, a checking operation regarding whether the address is overlapped will be described later with reference to FIGS. 3 and 4.

Referring to FIG. 2, the controller 160A can include different pipelines for processing a read command and a write command. For example, the controller 160A can include a write processing unit 206 configured to receive the write command from the command fetcher 204 to process the write command, and a read processing unit 208 configured to receive the read command from the command fetcher 204 to process the read command. According to an embodiment, each of the write processing unit 206 and the read processing unit 208 can include at least one pipeline structure. In addition, each of the write processing unit 206 and the read processing unit 208 can include at least one component for performing processing or handling for a data I/O command.

The controller 160A can include a buffer (write/read cache/buffer) 210 which is configured to temporarily store commands transmitted from the write processing unit 206 and the read processing unit 208, sequentially transmit the stored commands to the memory device 180 (see FIG. 1), and link a response transmitted from the memory device 180 with the command transmitted to the memory device 180.

According to the embodiment, the buffer 210 can be divided into a read command buffer that stores a read command and a write command buffer that stores a write command. In addition, the buffer 210 can include a plurality of sub buffers, each sub buffer corresponding to each of data paths or channels through which the controller 160A and the memory device 180 are operatively connected.

The host 110, which is an external device, can transmit a read command to the memory system 150. The controller 160A included in the memory system 150 can process or handle a read command. When processing the read command, the controller 160A can recognize where to transfer the read command among plural data storage regions, memory chips, or memory dies included in the memory device 180. After processing the read command, the controller 160A can store the processed read command in the buffer 210. The read command stored in the buffer 210 could be sequentially transferred to a preset location within the memory device 180. The memory device 180 that has received a read command and a physical address associated with the read command can output read data stored in a location of the physical address input along with the read command to the controller 160A. The buffer 210 can match the read data output by the memory device 180 with the read command temporarily stored before being transferred to the memory device 180. Thereafter, the controller 160A can transmit a response including the read data corresponding to the read command, previously input from the host 110, to the host 110.

The controller 160A described in FIG. 2 can improve the data I/O performance of the memory system by processing or handling the read command and the write command through different pipelines. Because the internal operations for processing commands are different based on presence or absence of data input along with the commands, address mapping for distributing or storing the data, or etc., efficient usage of resources and improvement of the data input/output (I/O) speed could be obtained while the commands are processed or handled through different pipelines.

In a case where plural data I/O commands (e.g., read command and write command) are accompanied by different addresses, data consistency might not be damaged or broken even if the controller 160A processes or handles each command through plural pipelines. Here, the data consistency can refer to the state of data where all copies of the data are the same across all systems (e.g., the memory system 150 and the host 110) regardless of data correctness or data integrity (e.g., an error in the data). Unlike the data consistency, the data integrity can refer to the state in which data values are correct. The data integrity could be guaranteed through an ECC module, etc. In order to keep or maintain the data consistency, the memory system 150 or the controller 160A needs to process or handle commands or requests input from the host 110, which is an external device, in order.

For example, the host 110 can request the memory system 150 to store data called ‘000’ at an address called ‘A’. Afterwards, when the host 110 requests data stored at the address called ‘A’ to the memory system 150, the memory system 150 can transfer the data called ‘000’ to the host 110. This is a case where the data consistency is maintained or kept.

However, the host 110 can request multiple write commands and multiple read commands to the memory system 150, along with the address called ‘A’. In this case, if the controller 160A in the memory system 150 stores or outputs data regardless of the order of the multiple write commands and multiple read commands, the host 110 can receive from the memory system 150 data which is different from data expected to be stored at the address called ‘A’. This is a case where data consistency is not maintained or kept.

FIG. 3 illustrates a first case for checking whether an address is overlapped.

Referring to FIG. 3, a command inputted by an external device such as the host 110 to the memory system 150 can be accompanied by an address. Here, the command is not related to a type (e.g., read command, write command), and the address can be a logical address LPN.

FIG. 3 shows accompanying addresses LPN based on a command sequence (CMD Sequence). Each of plural commands can be accompanied by two consecutive logical addresses. For example, a first command can be accompanied by a first logical address LPN0 and a second logical address LPN1, and a second command can be accompanied by the second logical address LPN1 and a third logical address LPN2. The addresses input accompanying the first and second commands can include a same address, i.e., the second logical address LPN1. This can indicate that at least some of the addresses input along with at least two commands, i.e., the first and second commands, are overlapped.

A third command can be accompanied by the third logical address LPN2 and a fourth logical address LPN3. The addresses input along with the second and third commands can include the third logical address LPN2. This can indicate that at least some of the addresses input along with the second and third commands are overlapped.

Likewise, a fourth command can be accompanied by the fourth logical address LPN3 and a fifth logical address LPN4. The addresses input along with the third and fourth commands can include the fourth logical address LPN3. This can show that at least some of the addresses input along with the third and fourth commands are overlapped.

When at least some of the addresses input along with plural command input from the host 110 are overlapped, the memory system 150 or the controller 160A should process or handle the plural commands based on a command input sequence (CMD Sequence) of the plural commands. Referring to FIG. 2, the controller 160A can include plural pipelines. If each of the plural pipelines independently processes a command, the plural commands could be processed or handled by the plural pipelines regardless of the command input sequence (CMD Sequence) of the plural commands so that a processing order might not be matched with the command input sequence. In this case, the data consistency might not be kept or maintained.

FIG. 4 illustrates a second case for checking whether the address is overlapped.

Referring to FIG. 4, each of plural commands can be input along with three consecutive logical addresses. For example, a first command can be accompanied by a first logical address LPN0, a second logical address LPN1, and a third logical address LPN2. A second command can be accompanied by the second logical address LPN1, the third logical address LPN2, and a fourth logical address LPN3. The addresses input along with the first and second commands can include the second logical address LPN1 and the third logical address LPN2. This can show that at least two of the addresses input along with the first and second commands are overlapped.

A third command can be accompanied by the third logical address LPN2, the fourth logical address LPN3, and a fifth logical address LPN4. The addresses input along with the first to third commands can include the third logical address LPN2. Further, the addresses input along with the second and third commands can include the fourth logical address LPN3. This can indicate that at least some of the addresses input along with the first, second, and third commands are overlapped.

Similarly, a fourth command can be accompanied by the fourth logical address LPN3, the fifth logical address LPN4, and a sixth logical address LPN5. The addresses input along with the second to fourth commands can include the fourth logical address LPN3. The addresses input along with the third and fourth commands can include the fifth logical address LPN4. This can indicate that at least some of the addresses input along with the second, third, and fourth commands are overlapped.

When at least some of addresses input along with at least two commands input from the host 110 are overlapped, the memory system 150 or the controller 160A should process or handle the plural commands according to a command input sequence (CMD Sequence) of the plural commands. Referring to FIG. 2, the controller 160A can include plural pipelines. Because each of the plural pipelines can independently process a command, the plural commands could be processed or handled by the plural pipelines regardless of the command input sequence (CMD Sequence) of the plural commands so that a processing order might not be matched with the command input sequence. In this case, data consistency might not be maintained or kept (e.g., broken).

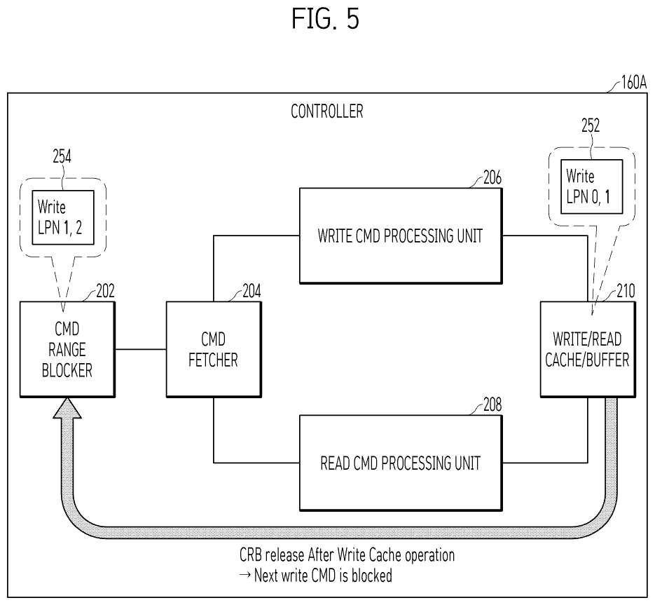

FIG. 5 illustrates an operation of the controller when the address is overlapped according to an embodiment of the present disclosure. FIG. 5 describes the operation for maintaining the data consistency through the controller 160A described in FIG. 2.

Referring to FIG. 5, a first write command 252 can be processed by the write processing unit 206 and then be stored in the buffer 210. Herein, the first write command 252 can be accompanied by a first logical address LPN0 and a second logical address LPN1.

The command range blocker 202 can temporarily block or suspend transmission of a second write command 254. This is because the second write command 254 is input along with the second logical address LPN1 and a third logical address LPN2. Because the first write command 252 and the second write command 254 are accompanied by a same address, i.e., the second logical address LPN1, at least some of the addresses input along with the first write command 252 and the second write command 254 are overlapped. In order for the controller 160A to process or handle the first write command 252 and the second write command 254 according to an input sequence, the command range blocker 202 can temporarily block or suspend the transmission of the second write command 254.

After the first write command 252 stored in the buffer 210 is transmitted to the memory device 180, the memory device 180 can transmit to the controller 160A a completion notification of a write operation performed based on the first write command 252. In response to the completion notification of the write operation, the controller 160A can generate a response for the first write command 252 and the first write command 252 could be released from the buffer 210. Releasing a specific command from the buffer 210 can indicate that the controller 160A no longer needs to track or monitor the specific command.

Immediately after the first write command 252 is input to the controller 160A, the second write command 254 can be input to the controller 160A. That is, no command may be input between the first write command 252 and the second write command 254. In this case, the command fetcher 204, the write processing unit 206, etc. within the controller 160A might not perform any operation for the second write command 254. If so, resource utilization within the controller 160A could be reduced, and the data I/O performance of the memory system 150 might not be improved.

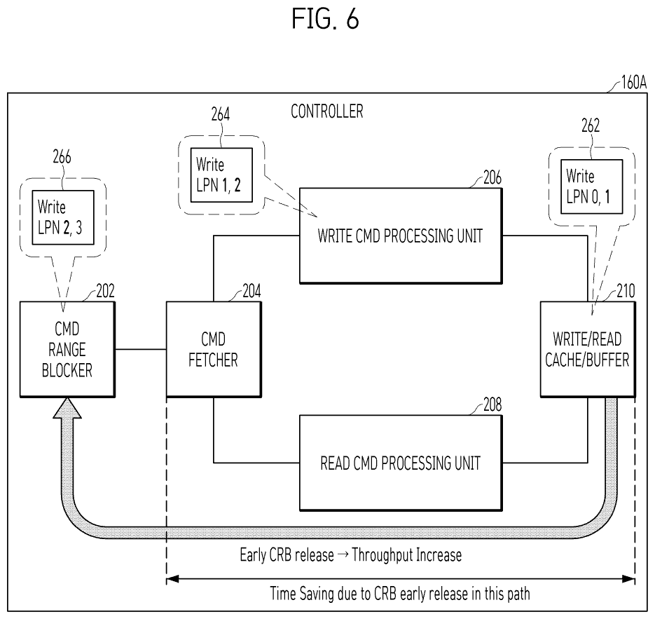

FIG. 6 illustrates a case where data consistency is maintained in the memory system. FIG. 6 shows a method for improving the operation of the controller 160A described in FIG. 5.

Referring to FIG. 6, a first write command 262 can be processed or handled by the write processing unit 206 and then be stored in the buffer 210. Herein, a first write command 262 can be input along with a first logical address LPN0 and a second logical address LPN1.

Unlike an operation of the command range blocker 202 described in FIG. 5, the command range blocker 202 can be configured to perform an operation which does not block (or suspend) the transmission of the second write command 264 but transmits the second write command 264 to the pipeline. The write processing unit 206 can process the second write command 264. Herein, the second write command 264 is accompanied by the second logical address LPN1 and the third logical address LPN2. Both the first write command 262 and the second write command 264 are accompanied by the second logical address LPN1. However, the buffer 210 can notify the command range blocker 202 of early completion corresponding to the first write command 262 (Early CRB Release).

Here, the early completion that the buffer 210 delivers to the command range blocker 202 can be distinguishable and different from the completion notification of the memory device 180 described in FIG. 5. The early completion is to notify that an operation corresponding to a command stored in the buffer 210 would be guaranteed in advance without receiving the completion notification from the memory device 180, after the command is delivered to the memory device 180. The early completion could be generated on the premise that the command delivered by the controller 160A to the memory device 180 will be executed without a problem. Regardless if the early completion after the first write command 252 stored in the buffer unit 210 is transmitted to the memory device 180, the first write command 252 corresponding to the early completion could be released after the memory device 180 transmits the completion notification to the controller 160A. The buffer 210 can track, monitor, and inspect a specific command corresponding to the early completion until the specific command is released based on a completion notification.

The command range blocker 202 can check the third write command 266 and then block the third write command 264 from being transmitted to the command fetcher 204. The third write command 266 can be accompanied by the third logical address LPN2 and the fourth logical address LPN3. The second write command 264 and the third write command 266 are accompanied by the third logical address LPN2. However, the second write command 264 could be still processed. Because there is no early completion corresponding to the second write command 264, the third write command 266 input along with the third logical address LPN2 could be temporarily blocked or suspended by the command range blocker 202.

Although at least some of the addresses accompanied by at least two sequentially input commands are overlapped, the buffer 210 can transmit the early completion to the command range blocker 202. Comparing the operations described in FIG. 5 and FIG. 6, the second write command 264 could not be blocked in response to the early completion by the command range blocker 202 and then might be processed by the write processing unit 206. Regarding the second write command 264, the controller 160A could reduce processing time due to the early completion (Time Saving).

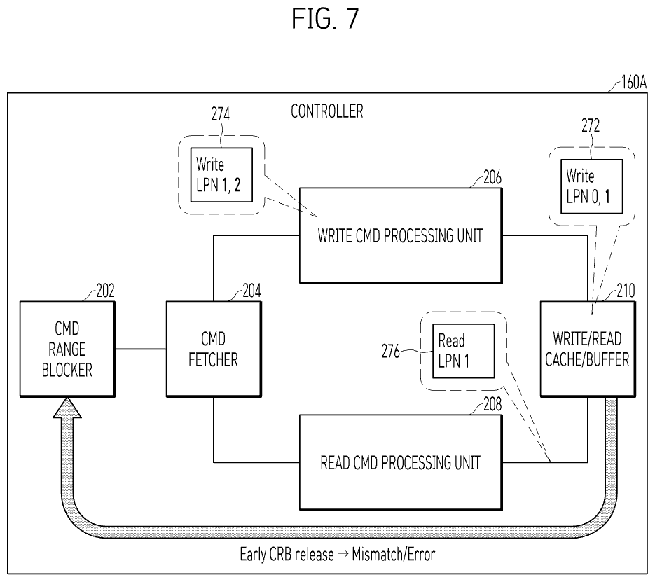

FIG. 7 illustrates a case where the data consistency is broken in the memory system. FIG. 7 shows a case where data consistency is not maintained due to a hazard during an operation corresponding to early completion.

Referring to FIG. 7, a first write command 272 can be processed or handled by the write processing unit 206 and then be stored in the buffer 210. Herein, the first write command 272 can be input along with a first logical address LPN0 and a second logical address LPN1.

Similar to the operation of FIG. 6, the buffer 210 can notify the command range blocker 202 of early completion regarding the first write command 272 (Early CRB Release). Thus, the command range blocker 202 could not block or suspend the transmission of the command due to address overlap of the first logical address LPN0 and the second logical address LPN1.

At this time, the second write command 274 and the first read command 274 can be transmitted to the pipeline through the command range blocker 202 and the command fetcher 204. The write processing unit 206 can process the second write command 274, while the read processing unit 208 can process the first read command 276. Herein, the second write command 274 and the first read command 276 are accompanied by the second logical address LPN1. Because the first write command 272, the second write command 274, and the first read command 276 are accompanied by a same address, i.e., the second logical address LPN1, at least some of the addresses input along with the first write command 272, the second write command 274, and the first read command 276 can be overlapped.

The second write command 274 and the first read command 276, which are different types of commands, could be processed through different pipelines. Because internal operations or tasks of the write command could be more complex than that of the read command, the time at which the read processing unit 208 completes processing the first read command 276 can be earlier than the time at which the write processing unit 206 completes processing the second write command 274. Referring to FIG. 7, the first read command 276 can be transmitted to and stored in the buffer 210 earlier than the second write command 274.

The host 110, which is an external device of the memory system 150, has transmitted plural commands to the memory system 150 in an order of the first write command 272, the second write command 274, and the first read command 276. However, the buffer 210 is configured to store the first write command 272, the first read command 276, and the second write command 274 in that order. Because at least some of the logical address input along with the first read command 276 and the second write command 274 are overlapped, the data consistency of the read data corresponding to the first read command 276 might not be maintained or kept.

Accordingly, the early completion transmitted by the buffer 210 to the command range blocker 202 can cause a different result from a case described in FIG. 6. The early completion can indicate that the command stored in the buffer 210 is completed in advance without a completion notification from the memory device 180 after the command has been transmitted to the memory device 180. However, when at least some of the addresses input along with three or more commands is overlapped, it could be difficult to keep or maintain data consistency. Early completion can be generated based on that the command transmitted by the controller 160A to the memory device 180 will be executed without a problem, but different (or inconsistent) data could be output to the host 110 as a command order is changed.

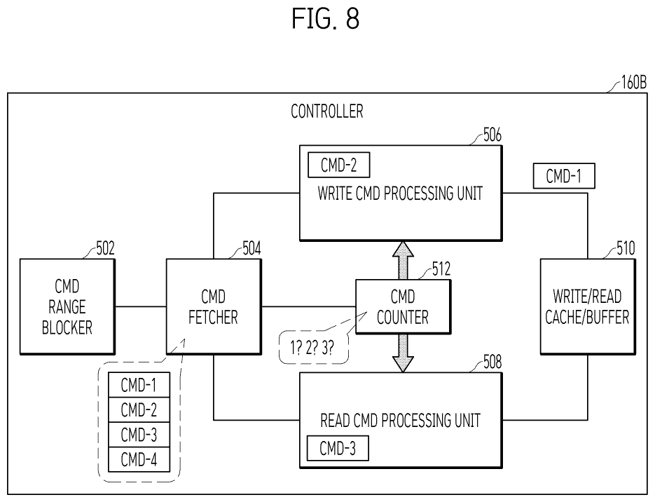

FIG. 8 illustrates another controller according to an embodiment of the present disclosure.

Referring to FIG. 8, the controller 160B can include a command range blocker (CMD range blocker) 502, a command fetcher (CMD fetcher) 504, a write processing unit 506, a read processing unit 508, and a buffer (write/read cache/buffer) 510. The command range blocker 502, the command fetcher 504, the write processing unit 506, the read processing unit 508, and the buffer 510 can correspond to the command range blocker 202, the command fetcher 204, the write processing unit 206, the read processing unit 208, and the buffer 210 described in FIG. 2. In FIG. 8, description focuses on differences between the controller 160B and the controller 160A which is described in FIG. 2.

The command fetcher 504 included in the controller 160B can assign a sequence number to a command transmitted from the command range blocker 502. For example, the number ‘1’ could be assigned to the first command, the number ‘2’ could be assigned to the second command, and the number ‘3’ could be assigned to the third command. The command fetcher 504 can assign a sequence (or successive numbers) to plural commands transmitted from the command range blocker 502 and then transmit the plural commands to the write processing unit 506 and the read processing unit 508.

The controller 160B can further include a command counter (CMD counter) 512. The command counter 512 can check the number assigned to the command processed in the write processing unit 506 and the read processing unit 508 (1? 2? 3?). The command counter 512 can adjust the command to be processed in the write processing unit 506 and the read processing unit 508 according to the sequence. The command counter 512 could receive information on a range and a sequence number assigned to the plural commands whose sequence should be maintained from the command fetcher 504.

For example, four commands are transmitted to the command fetcher 504. The command fetcher 504 can assign sequential numbers to the four commands CMD-1, CMD-2, CMD-3, CMD-4. Here, at least some of the addresses inputted along with the four commands can be overlapped.

The first command CMD-1 is a write command, so the first command CMD-1 can be processed through the write processing unit 506. The write processing unit 506 can transmit the first command CMD-1 to the buffer unit 510. At this time, the command counter 512 could recognize that the first command CMD-1 among the plural commands has been transmitted to the buffer 510.

The second command CMD-2 is a write command, so the second command CMD-2 can be processed through the write processing unit 506. The write processing unit 506 can transmit the second command CMD-2 to the buffer 510 when an operation of processing the second command CMD-2 is completed. At this time, the command counter 512 can determine whether the second command CMD-2 processed by the write processing unit 506 can be transmitted to the buffer 510. The command counter 512 can check that there is no problem even if the second command CMD-1 is transmitted to the buffer 510, because the first command CMD-1 is transmitted to the buffer 510.

Further, the third command CMD-3 is a read command, so the third command CMD-3 could be processed by the read processing unit 508. As described in FIG. 7, the read processing unit 508 might not perform as complicated operations as the write processing unit 506. After the read processing unit 508 completes the processing for the third command CMD-3, the third command CMD-3 could be transmitted to the buffer 510. At this time, the command counter 512 can determine whether the third command CMD-3 processed in the read processing unit 508 can be transmitted to the buffer 510. The command counter 512 can confirm that the third command CMD-3 should not be transmitted to the buffer 510 because the first command CMD-1 was transmitted to the buffer 510 and the second command CMD-1 was not transmitted to the buffer 510.

The command counter 512 can check or monitor the write processing unit 506 and the read processing unit 508 to adjust an order in which processed commands are transmitted to the buffer 510. In FIG. 8, after the write processing unit 506 transmits the second command CMD-2 to the buffer 510 by the command counter 512, the read processing unit 508 could transmit the third command CMD-3 to the buffer 510.

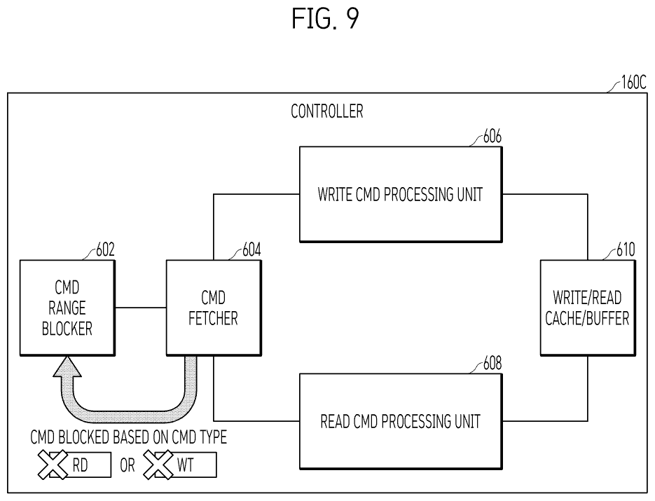

FIG. 9 illustrates yet another controller according to an embodiment of the present disclosure.

Referring to FIG. 9, the controller 160C can include a command range blocker CMD range blocker) 602, a command fetcher (CMD fetcher) 604, a write processing unit 606, a read processing unit 608, and a buffer (write/read cache/buffer) 610. The command range blocker 602, the command fetcher 604, the write processing unit 606, the read processing unit 608, and the buffer 610 can correspond to the command range blocker 202, the command fetcher 204, the write processing unit 206, the read processing unit 208, and the buffer 210 described in FIG. 2. FIG. 9 will focus on the differences between the controller 160C and the controller 160A which is shown in FIG. 2.

According to an embodiment, the command fetcher 604 can request the command range blocker 602 to block or suspend command transmission based on a type of the command. For example, if at least some of the addresses input along with plural commands are overlapped, the command fetcher 604 can request the command range blocker 602 to block or suspend the transmission of the read command RD. If at least some of the addresses input along with consecutive commands are overlapped, the validity of previously stored data might not be guaranteed because data can be continuously updated or amended within a short period of time. At this time, it would be important for the memory system 150 to sequentially perform the write commands. Accordingly, the command range blocker 602 can block or suspend the transmission of the read command, so that the controller 160C can sequentially process the plural commands and transmit the plural commands to the memory device 180. If only a same type of command can be processed and there is only one pipeline for processing the command, an execution order of the plural commands in the controller 160C could not be reversed.

According to an embodiment, if at least some of the addresses input along with plural commands are overlapped, the command fetcher 604 can request the command range blocker 602 to block or suspend transmission of the write command WT. For example, blocking transmission of the write command WT could be possible only when the data consistency might not be broken by the write command included in the plural commands.

FIG. 10 illustrates a memory system according to an embodiment of the present disclosure. FIG. 10 shows a memory system including multiple cores or multiple processors, which is an example of a data storage system. The memory system may support a Non-Volatile Memory Express protocol (NVMe).

The NVMe is a type of transfer protocol designed for a solid-state memory that can operate much faster than a conventional hard drive. The NVMe can support higher input/output operations per second (IOPS) and lower latency, resulting in faster data transfer speeds and improved overall performance of the data storage system. Unlike SATA, which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not be able to process a large number of I/O requests in parallel.

Referring to FIG. 10, a host, which is an external device, can be coupled to the memory system through a plurality of PCIe Gen 3.0 lanes, a PCIe physical layer (PCIe PHY) 412, and a PCIe core 414. A controller 400 may include three embedded processors 432A, 432B, 432C, each using a plurality of cores 402A, 402B. Herein, the plurality of cores 402A, 402B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low Density Parity-Check (LDPC) sequencer 460, a Direct Memory Access (DMA) engine 420, a scratch pad memory 450 for metadata management, and an NVMe controller 410. Components within the controller 400 may be coupled to a plurality of channels connected to a plurality of memory packages (Flash) 452 through a flash physical layer (NAND flash PHY) 440. The plurality of memory packages 452 may correspond to a plurality of memory chips in a memory die 222 described above with reference to FIG. 1.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, a scratch pad memory 450 may be a storage area set by the NVMe controller 410 to temporarily store data. The scratch pad memory 450 may be used to store data waiting to be written to a plurality of memory packages 452. The scratch pad memory 450 can also be used as a buffer to speed up the writing process, typically with a small amount of Dynamic Random Access Memory (DRAM) or Static Random Access Memory (SRAM). When a write command is executed, data may first be written to the scratch pad memory 450 and then transferred to the plurality of memory packages 452 in larger blocks. The scratch pad memory 450 may be used as a temporary memory buffer to help optimize the write performance of the plurality of memory packages 452. The scratch pad memory 450 may serve as intermediate storage for data before the data is written to non-volatile memory cells.

The Direct Memory Access (DMA) engine 420 included in the controller 400 is a component that transfers data between the NVMe controller 410 and a host memory in the host system without involving a host's processor. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of memory packages 452. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into a plurality of blocks, encode each block using an LDPC code, and store the encoded data in the plurality of memory packages 452. Thereafter, when reading the encoded data from the plurality of memory packages 452, the LDPC sequencer 460 can decode the encoded data based on the LDPC code and correct errors that may have occurred during a write or read operation. The LDPC sequencer 460 may correspond to an ECC circuitry included in the controller of the memory system.

FIG. 11 illustrates a data processing apparatus according to an embodiment of the present disclosure.

Referring to FIG. 11, the data processing device may include a host 302 and a memory system (e.g., compute express link (CXL™) device) 310. The host 302 and the memory system 310 can perform data communication via a computer-memory link-based (e.g., CXL™) protocol or interface. A controller 312 within the memory system 310 can include a priority controller 108, a hazard control unit 110, and a memory controller 112 as described in FIG. 11. The controller 312 can manage and control data input/output (I/O) operations performed in a memory device (or a CXL™ memory device) 314 based on priorities assigned to plural data input/output (I/O) requests.

The memory system 310 can be designed to support memory-centric computing technology. The memory-centric computing technology can provide a dynamically scalable shared memory that overcomes the limitations of large-capacity data processing performance and capacity occurring in one type of CPU-centric systems that have been proposed, in line with demands or requirements for a memory disaggregation system. Thus, the system scale can be flexibly maintained in line with requirements regarding the data processing apparatus. Due to the explosive increase in amounts of data from emerging applications such as big data and artificial intelligence (AI), the data processing apparatus including at least one computing device can be designed or built to satisfy large-capacity, high-bandwidth memory, or innovative architectural changes. The number of servers and memory devices can continue to increase to meet overwhelming memory requirements. The computer-memory link-based protocol or computer-memory link-based interface can be provided to support large-capacity and high-bandwidth memory.

Memory disaggregation can be an architectural solution that separates a memory (e.g., a memory device) from a compute node (e.g., a computing device), allowing a system designer to flexibly expand additional memory capacity independently of each computing server while meeting the memory requirements of user applications. For example, a computing server with high memory usage can use a memory device located farther away from other nodes included in a disaggregated group. Accordingly, this disaggregation scheme can manage or use resources more efficiently than one type of dedicated CPU and memory architectures that have been proposed.

The computer-memory link (e.g., Compute Express Link, CXL™) can be provided to accelerate architectural transition to memory disaggregation. The computer-memory link is an industry-supported cache-coherent interconnect (CCI) for various processors to efficiently expand memory capacity through a memory semantic protocol. Unlike a host memory 306 that is entirely dependent on a host central processing unit (host CPU) 304, a memory device 314 connected via the CXL-based protocol or CXL-based interface to the host 302 can include additional data or values such as data processing engines through handshaking communication, as a memory.

The host 302 can include the host central processing unit 304 and the host memory 306. The number and configuration of the host central processing units (e.g., CPU) 304 and the host memory 306 can vary depending on the performance, operating requirements, operating speed, and data input/output (I/O) speed of the host 302. The host central processing unit 304 and the host memory 306 can transmit and receive data through a communication interface protocol mutually agreed upon with each other. There are various communication standards or interfaces such as Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe), Serial-attached SCSI (SAS), Serial Advanced Technology Attachment (SATA), and Mobile Industry Processor Interface (MIPI), as examples of agreed upon standards for transmitting and receiving data. According to an embodiment, the host 302 and the host memory 306 can be coupled via a Universal Serial Bus (USB). The Universal Serial Bus (USB) can include an expandable, hot-pluggable plug-and-play serial interface that ensures an economical standard connection to peripheral devices such as a keyboard, mouse, joystick, printer, scanner, storage device, modem, video conferencing camera, etc.

In FIG. 11, the host 302 can perform data communication with the memory system 310 through the computer-memory link-based protocol or interface (e.g., CXL™ protocol or CXL™ interface). CXL™ (Compute Express Link) and PCIe (Peripheral Component Interconnect Express) are both standard interfaces for connecting peripherals and CPUs in a computer system. However, there are differences in several aspects between the CXL™ and the PCIe. First, the PCIe is designed as a standard for general input/output devices, while the CXL™ is an interface specialized for memory access and high-speed data transmission in a high-performance computing environment. Thus, the CXL™ is designed so that the CPU can directly access the memory of the device, while the PCIe may have limited such functions. In addition, while the PCIe uses a unidirectional communication way, the CXL™ can support bidirectional communication. For example, the CXL™ devices can support to send and receive data simultaneously. Because the CXL™ is designed to maintain backward compatibility with the PCIe, the CXL™ device could be designed or implemented by utilizing one type of PCIe infrastructure that has been proposed.

According to an embodiment, data communication of the memory device 314 (e.g., a CXL™ memory device) distributed to the host central processing unit (e.g. CPU) 304 may have a limited interface bandwidth, as compared to that of the host memory 306. For example, in cases of DDR4 DIMM and DDR5 DIMM used as the host memory 306, the DIMM has 64-bit (i.e., 8-byte) data width. The maximum bandwidth could be 2.56 GB/s (=3.2 Gbps×8 bytes) for DDR4 and 38.4 GB/s (=4.8 Gbps×8 bytes) or 51.2 GB/s (=6.4 Gbps×8 bytes) for DDR5. Accordingly, the interface bandwidth may be 0.4 s⁻¹ (=25.6GB/s/64 GB) and 0.6^{s-1} (=38.4 GB/s/64 GB) or 0.8^{s-1} (=51.2 GB/s/64 GB) when a storage capacity of each chip is 64 Gb. On the other hand, the interface bandwidth of the memory system 310 may be very limited to 0.0625^{s-1} (=32 GB/s(@PCIe5.0×8)/512 GB). This bandwidth difference can limit the input/output performance of the data processing apparatus.

To overcome above-described issues, the memory system 310 may include a Memory controller 312 (e.g., a CXL™ core) designed and used for near data processing (NDP) (or near-distance data processing). The near data processing (NDP) can be a computing scheme for improving or enhancing the efficiency of data processing. The near data processing (NDP) could be based on a configuration in which the memory controller 312 (e.g., at least one processor or core that processes data) is arranged or located close to a data storage or memory such as the memory device 314.

In one type of computing model that has been proposed, the host central processing unit 304 would retrieve data from the memory device 314 coupled to expand the host memory 306, process the data, and store results back in the memory device 314. However, in applications that require processing a large amount of data, that scheme could cause a bandwidth bottleneck between the memory device 314 and the host central processing unit 304. To solve this issue, the near data processing (NDP) can be designed to place the memory controller 312 (e.g., a processor that processes data) close to the memory device 314 in which the processed data is stored. That is, instead of moving data from the memory device 314 to the host central processing unit 304, the memory controller 312, which is the processor that performs data processing, can be included in the memory system 310 which is the location of the data. This configuration can significantly reduce or avoid delay time and energy consumption due to data movement.

Unlike the memory system 310, the host memory 306 can be used for in-memory processing of the host central processing unit 304. In-memory processing can store as much data as possible in the host memory 306 and reduce the delay time due to disk I/O (e.g., I/O of the memory system). The host memory 306 under this scheme could support great performance in database work, real-time analysis, etc. However, because the host memory 306 is expensive and has limited capacity, there may be limitations in processing very large data sets. Thus, the data processing apparatus can overcome some limitations of operation and performance of the host memory 306 through the memory system 310 including the memory controller 312 for the near data processing (NDP).

As above described, a memory system according to an embodiment of the present disclosure can dynamically and adaptively determine scheduling of data input/output requests according to an input order and a type of commands. Accordingly, even if a difference between the number of data input/output requests with a first number and the number of data input/output requests with a second number increases, the difference could be reduced quickly while processing or handling operations corresponding to data input/output requests based on the scheduling determined based on the input order. Through this, the memory system can more efficiently use resources for processing.

The controllers 160, 400, 312 described in FIG. 1, FIG. 10, and FIG. 11 can improve the data I/O performance of the memory device 180, 314 or the memory package 452 through components or a structure of parallel processing or pipelining. In addition, even if the controllers 160, 400, 312 can process plural commands such as read commands and write commands through different pipelines, the controllers 160, 400, 312 can control the data I/O commands to be transmitted to the memory device 180, 314 or the memory package 452 according to an order of the data I/O commands input by the host 110, 302, which is an external device, to the memory system 150, 310 or the controller 400, thereby maintaining the data consistency. Additionally, according to an embodiment, the controller 160, 400, 312 can avoid or prevent system errors or crashes in a procedure of processing plural data I/O commands through plural pipelines.

As above described, a memory system according to an embodiment of the present disclosure can maintain data consistency through a scheduling apparatus and an operation method that can control or adjust the transmission or processing order of data I/O commands or requests in parallel processing to improve the data I/O performance even in a specific situation where addresses, input for different commands or requests, are overlapped.

In addition, a memory system according to an embodiment of the present disclosure can maintain data consistency in a pipeline for parallel processing even in a specific situation where addresses, input for different commands or requests, are overlapped, as well as reduce a delay in processing data I/O commands or requests.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the invention has been illustrated and described with respect to the specific embodiments, it will be apparent to those skilled in the art in light of the present disclosure that various changes and modifications may be made without departing from the spirit and scope of the present disclosure as defined in the following claims. Furthermore, the embodiments may be combined to form additional embodiments.

What is claimed is:

1. A memory system comprising:
a memory device comprising at least one storage region; and
a controller coupled to the memory device and configured to transmit to the memory device a command used for storing data in the at least one storage region or reading stored data from the at least one storage region,
wherein the controller is configured to differently perform scheduling, based on whether addresses, input along with at least two commands belonging to a preset range of commands to be transmitted to the memory device, are overlapped, so that a first order in which the commands are input from an external device is equal to a second order in which the commands are transmitted to the memory device.

2. The memory system according to claim 1, wherein the controller is configured to compare addresses corresponding to a specific command with addresses corresponding to at least one of a first command and a second command to determine whether the addresses are overlapped, the first command input immediately before the specific command, the second command input immediately after the specific command.

3. The memory system according to claim 2, wherein the controller is configured to transmit to the memory device the specific command after transmitting the first command when at least one of the addresses corresponding to the specific command is equal to at least one of the addresses corresponding to the first command.

4. The memory system according to claim 2, wherein the controller is configured to transmit to the memory device the specific command before transmitting the second command when at least one of the addresses corresponding to the specific command is equal to at least one of the addresses corresponding to the second command.

5. The memory system according to claim 2, wherein the controller is configured to change a transmitting order of the specific command, the first command, and the second command, based on a type of the specific command, the first command, and the second command, when none of the addresses corresponding to the specific command is equal to the addresses corresponding to the first command or the addresses corresponding to the second command.

6. The memory system according to claim 1, wherein the controller is configured to determine whether to perform the scheduling regardless of types of the commands.

7. The memory system according to claim 1, wherein the controller comprises:
a command range blocker configured to determine whether to process or handle the commands;
a command fetcher configured to determine whether the addresses are overlapped, after receiving the commands transmitted from the command range blocker, and transmit the commands to different paths based on types of the commands;
a write processing unit configured to receive a write command from the command fetcher and process or handle the write command;
a read processing unit configured to receive a read command from the command fetcher and process or handle the read command; and
a buffer configured to store the write or read command transmitted from the write processing unit or the read processing unit, sequentially transmit the stored write or read command to the memory device, and link a response transmitted from the memory device with the transmitted write or read command.

8. The memory system according to claim 7, wherein the command fetcher is further configured to assign a number to a command transmitted from the command range blocker according to a transmitting order based on whether the addresses are overlapped,
wherein the controller further comprises a command counter configured to:
check the number assigned to the command which is to be processed by the write processing unit or the read processing unit; and
adjust or change an order of processing the command in the write processing unit or the read processing unit based on the first order.

9. The memory system according to claim 7,
wherein the command fetcher is configured to request the command range blocker to block transmission of one of the read command or the write command based on whether the addresses are overlapped, and
wherein the command range blocker is configured to block the transmission of one of the read command or the write command based on a request of the command fetcher.

10. The memory system according to claim 7,
wherein the addresses comprise logical addresses used by the external device, and
wherein each of the write processing unit and the read processing unit comprises a Flash Translation Layer (FTL).

11. A method for operating a memory system, the method comprising:
determining whether addresses, input along with at least two commands belonging to a preset range of commands to be transmitted to the memory device, are overlapped;
performing scheduling, so that a first order in which the commands are input from an external device is equal to a second order in which the commands are transmitted to the memory device, when the addresses are overlapped;
processing the commands without the scheduling when the addresses are not overlapped; and
sequentially transmitting processed or scheduled commands to a memory device.

12. The method according to claim 11, wherein the determining whether the addresses are overlapped comprises:
comparing addresses corresponding to a specific command with addresses corresponding to at least one of a first command and a second command, the first command input immediately before the specific command, the second command input immediately after the specific command; and
determining whether the addresses are overlapped based on a comparison result.

13. The method according to claim 12, wherein the performing scheduling comprises:
transmitting the specific command to the memory device after transmitting the first command based on the comparison result; and
transmitting the specific command to the memory device before transmitting the second command based on the comparison result.

14. The method according to claim 12, wherein the processing the commands comprises:
processing the specific command, the first command, and the second command based on types of the specific command, the first command, and the second command regardless of an input order of the specific command, the first command, and the second command.

15. The method according to claim 11, wherein the performing the scheduling comprises:
assigning a number according to an input order to each of the commands based on whether the addresses are overlapped; and
sequentially processing each of the commands based on an assigned number.

16. The method according to claim 11, wherein the performing the scheduling comprises:
suspending transmission of one of a read command and a write command based on whether the addresses are overlapped.

17. A memory system comprising:
a memory device storing data; and
a controller configured to make a first order in which read commands and write commands are input from an external device and a second order in which the read commands and the write commands are transmitted to the memory device to be identical when at least one of addresses input along with the read commands and the write commands is overlapped, while processing the read commands and the write commands to be transmitted to the memory device through separate paths in the controller.

18. The memory system according to claim 17, wherein the controller is configured to transmit the read commands and the write commands to the memory device through the separate paths regardless of the first order in which the read commands and the write commands are input from the external device when at least one of addresses input along with the read commands and the write commands is not overlapped.

19. The memory system according to claim 17, wherein the controller is configured to:
assign numbers to the read commands and the write commands based on the first order in which the read commands and the write commands are input from the external device; and
transmit the read commands and the write commands to the memory device based on an order of the assigned numbers.

20. The memory system according to claim 17, wherein the controller is configured to suspend transmission of either the read commands or the write commands when the at least one of the addresses is overlapped.
